(19) United States
(12) Patent Application Publication
(10) Pub. No.: US 2011/0137816 A1
(43) Pub. Date: Jun. 9, 2011

(54) METHOD AND SYSTEM FOR PROVIDING A COLLABORATION RECOMMENDATION

(75) Inventors: Robert E. Kornblum, Sudbury, MA (US); Patrick D. Doherty, Mansfield, MA (US); Geoffrey D. Greene, Dover, MA (US); Arthur L.P. Papas, Weston, MA (US)

(73) Assignee: Bullhorn, Inc., Boston, MA (US)

(21) Appl. No.: 12/632,660

(22) Filed: Dec. 7, 2009

(51) Int. Cl. G06Q 10/00; G06F 17/30

(52) U.S. Cl. 705/321; 707/602; 707/758; 707/E17.005

(57) ABSTRACT

In a recruitment context, it can be difficult to determine the best third-party recruiter to help fill an open job. The disclosed system includes a recommendation engine that determines the best recruiter to help fill an open job, either for another recruiter to collaborate in a split-fee placement or for an employer having the opening. For a given candidate or job opening that becomes available and that is represented by a given user, the system analyzes disparate work information from users' transactional systems, including various criteria about their past transactions (job placements, geography, timeliness, etc.) and their current candidates to produce a recommendation. The user representing the subject candidate or job opening may then be notified of potential other users, and connected with them through an online system, in order to complete a collaborative placement.

### BACKGROUND OF THE INVENTION

The terms “split,” “splits,” “splits network,” “split placement,” “shared placement,” “recruiter network,” or the like refer to the staffing or recruitment industry practice of sharing job orders (i.e., job openings) or candidates (i.e., job seekers). Shared placement agreements allow a recruiter to post and match its job orders with another recruiter's posted candidates in an attempt to make a shared placement, with the placement fee or mark-up typically being split between the two recruiters. Some splits services offer some degree of security in being paid, along with various community-like services or features including database access.

Typically, a recruiter signs-up with a split placement service or recruiter network. The service may then allow recruiters to manually find matches between posted job openings and posted candidates and let the respective recruiters reach or contact each other. The two recruiters would then split the associated placement fee if the candidate fills the job opening. The same approach may also apply to contract or temporary recruiting.

### SUMMARY OF THE INVENTION

Although there exist technologies that match job openings with candidates, these are typically used internally matching one's job orders with one's candidates. They do not provide recommendations to their users regarding possible pairings between users in the absence of manual matches of posted job openings and candidates. For example, a recruiter that represents a number of candidates may not post many of its candidates to a split-fee or recruiter network. Thus, if a posted job opening does not match any of the posted candidates, but would match a non-posted candidate, the match will likely not be discovered, resulting in lost placement fees for the recruiters involved.

The disclosed embodiments do not simply match job openings to candidates, but use information generated by recruiters during their day-to-day business to determine which recruiters have the best chance of completing a collaborative placement. For example, for a given candidate that becomes available, an embodiment may search the past activity of other recruiters that may possibly have a job opening suited for that candidate (i.e., has a track record of such job openings). Similarly, for a given job opening that becomes available, an embodiment may search the past placement activity of other recruiters that may possibly have a candidate suited for that job opening (i.e., has a track record of having such candidates). A recruiter may then be notified that there exist potential other recruiters to contact in order to complete a shared, collaborative placement. The system may be used not only by recruiters that represent job openings and available candidates, but by employer entities looking to find the best recruiter to fill their job openings.

According to one embodiment, a recommendation for recruiter collaboration is provided by accessing disparate work information regarding a number of recruiters, where the work information has originally been generated by the recruiters in the course of transacting their business and stored in a hosted or on-premise software system. At least one of the recruiters is then identified based on the disparate work information, and a recommendation for collaboration with the identified recruiter is generated.

In some embodiments, the work information includes historical placement information regarding past placements made by the recruiters and identification of the recruiters is based on the historical placement information. In further embodiments, the recruiter may be identified by comparing information regarding a current job opening to the historical placement information, and may include comparing a title, description, or skill set of the current job opening to titles, description, or skill sets in the historical placement information. If the historical placement information includes copies of previously placed candidate' resumes, the recruiter may be identified by comparing the information regarding the current job opening to the copies of resumes in the historical placement information. In many embodiments, the identified recruiter or recruiters are those likely to be representing a candidate that matches the current job opening.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1 is a block diagram illustrating a shared placement network.

FIG. 2 is a block diagram illustrating a shared placement network capable of providing a recommendation of a shared placement collaboration, according to the principles of the present invention.

FIG. 3 is a flow diagram of a recommendation engine in the embodiment of FIG. 2 providing a recommendation of a shared placement collaboration.

FIG. 4 is a flow diagram illustrating example ways in one embodiment to identify recruiters based on historical placement information.

FIG. 5 is a block diagram of an embodiment having a shared placement network capable of providing a recommendation for recruiter collaboration.

FIG. 6 is a flow diagram of a recommendation engine in the embodiment of FIG. 5 providing a recommendation for recruiter collaboration.

FIG. 7 is a block diagram illustrating a system for connecting two users of a software-as-a-service (SaaS) system, according to principles of the present invention.

FIG. 8 is a schematic view of a computer network in which embodiments of the present invention may operate.

FIG. 9 is a block diagram of a computer node/device in the network of FIG. 8.

### DETAILED DESCRIPTION OF THE INVENTION

A description of example embodiments of the invention follows.

A typical recruiter network service requires that the recruiters using the service post their currently open jobs or currently available candidates to the service, such as via a website, for the other recruiters to browse and propose split-fee arrangements, or other shared collaboration efforts. As used herein, the term “recruiter” may refer to a sole recruiter (e.g., an individual agent or representative), a recruiting agency with multiple recruiters (e.g., agents/representatives), or an employer entity having open jobs to fill. Recruiters attempt to fill open jobs or place available candidates with potential employers. Recruiters deal with many types of jobs, including full-time jobs, part-time jobs, and staffing (e.g., contract or temporary positions). For clarity, recruiters associated with a job opening may be called “job-representing recruiters,” and recruiters associated with candidates may be called “candidate-representing recruiters.” Most often, recruiters represent both jobs and candidates. As used herein, the term “job-representing recruiter” refers to a recruiter that has at least one job opening to be filled, and the term “candidate-representing recruiter” refers to a recruiter that has at least one candidate to be placed in a job, but job-representing recruiters and candidate-representing recruiters may also represent candidates and jobs, respectively.

Using split-fee (or other shared placement) network services, candidate-representing recruiters can see the jobs posted by the job-representing recruiters and approach a job-representing recruiter to suggest a partnership on a particular job. Likewise, job-representing recruiters can see the candidates posted by the candidate-representing recruiters and approach a candidate-representing recruiter to suggest a partnership regarding a particular candidate. These types of services have limited usage, compared to the totality of recruiters, however, because job-representing recruiters are often reluctant to post jobs widely given the contingent nature of the recruiting industry. Similarly, candidate-representing recruiters are unlikely to post their candidates. Both participants approach new trading partnerships with apprehension over misappropriation of their asset (e.g., job opening or candidate).

The disclosed embodiments include an automated system that helps two recruiters discover, communicate, and transact job placements together. Recruiters typically use software systems to manage their day-to-day business transactions. These systems may be used for email, tracking candidates or jobs, and customer relationship management (CRM). If hosted and accessed over the Internet, these software services are known as Software-as-a-Service (SaaS). An example system may include a database used to keep track of open jobs or eligible candidates, including what actions have been performed and in relation to which jobs or candidates, and used to keep track of customers, including address and other contact information. A provider of these SaaS systems may host many different business entities' email, candidate, and customer information, but each entity only has access to its own such information.

There exist split-fee network services, where users (e.g., job-representing recruiters and candidate-representing recruiters) may post jobs and candidates that are available to be shared in a split-fee placement, but, given the contingent nature of the recruiting industry, the users may be hesitant to share their potential transactions (e.g., open jobs and available candidates). In the disclosed embodiments, instead of users posting their potential transactions for all other users to see, a user may opt-in to be notified by the system of possible split-fee arrangements. The system may then access the opted-in users' information, determine whether an optimal collaboration between users is likely, and notify the respective users of the possible collaboration. In addition, or in the alternative, the system may determine, for a given job opening or candidate, whether there exist any other users that may have a corresponding candidate or job opening, respectively, even though the corresponding candidate or job opening information may not be stored in the system. The system may make such a determination based on historical placement data (e.g., past placement made by the users through the system), and may notify at least one of the users of the possible pairing.

Such a system is confidential (e.g., not based on job postings) and data driven as the system may search across all users to discover the “best” trading partners for job/candidate-representing recruiters based on which other job/candidate-representing recruiters have done similar placements. The system may include built-in communication, built-in, modifiable terms of partnership, and may enable users to define or automate which jobs or candidates are available for split partnerships.

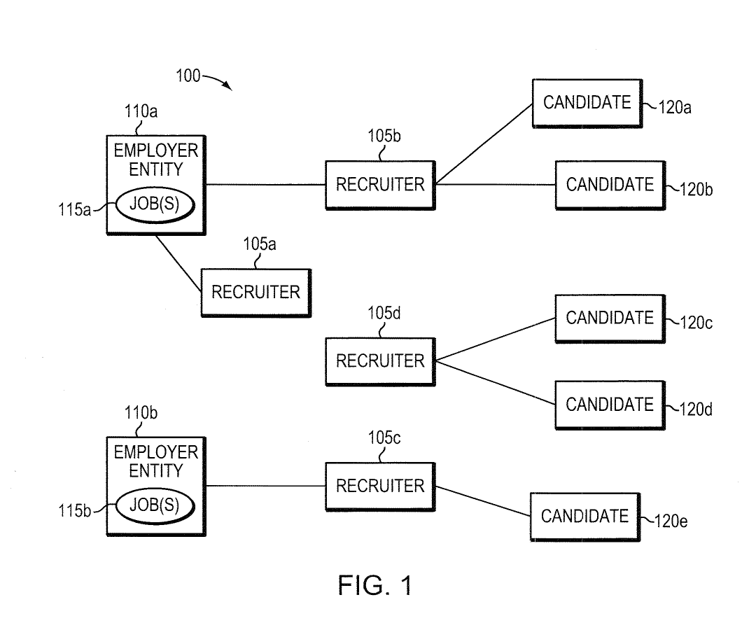

FIG. 1 is a block diagram illustrating a split-fee placement network 100. Recruiters 105a-d representing either employer entities with open jobs, candidates, or both are participants in the network. Recruiter 105a represents employer entity 110a, which has a job opening 115a. Employer entity 110a is also represented by recruiter 105b, which represents candidates 120a and 120b. Recruiter 105c represents employer entity 110b, which has a job opening 115b, and represents candidate 120e. Recruiter 105d represents candidates 120c and 120d. Each recruiter may search its own records to determine if there is a match between one of the jobs it represents and a candidate it also represents. If one of the recruiter's candidates is placed in a job that the recruiter also represents, then the recruiter would not need to split a fee with anyone for the placement. For example, recruiter 105b may be able to place either candidate 120a or 120b in job 115a. This is the ideal scenario for a recruiter. But recruiters often do not have any suitable candidates to match with its open jobs, or any suitable jobs to match with its available candidates. In this situation, a recruiter may look to partner with another recruiter that has a suitable job or candidate, and typically splits a placement fee with the other recruiter. For example, recruiter 105a, who represents job 115a, may partner with recruiter 105d, who represents candidates 120c and 120d. If either candidate 120c or 120d is placed in the job 115a, then recruiters 105a and 105d split any fee associated with the placement. The same approach may also apply to contract or temporary recruiting.

The recruiters typically find such split-fee arrangement by posting their jobs and candidates they are willing to share to a common area, such as a website service. But the posting approach has many problems including reluctance by the recruiters 105a-d to share their potential transaction subjects (assets) 115a, 115b, 120a-e and also a lack of users using the same posting service. On the other hand, a system that integrates the recruiters' 105a-d day-to-day work information may leverage that information to determine possible shared placement arrangements for the recruiters 105a-d.

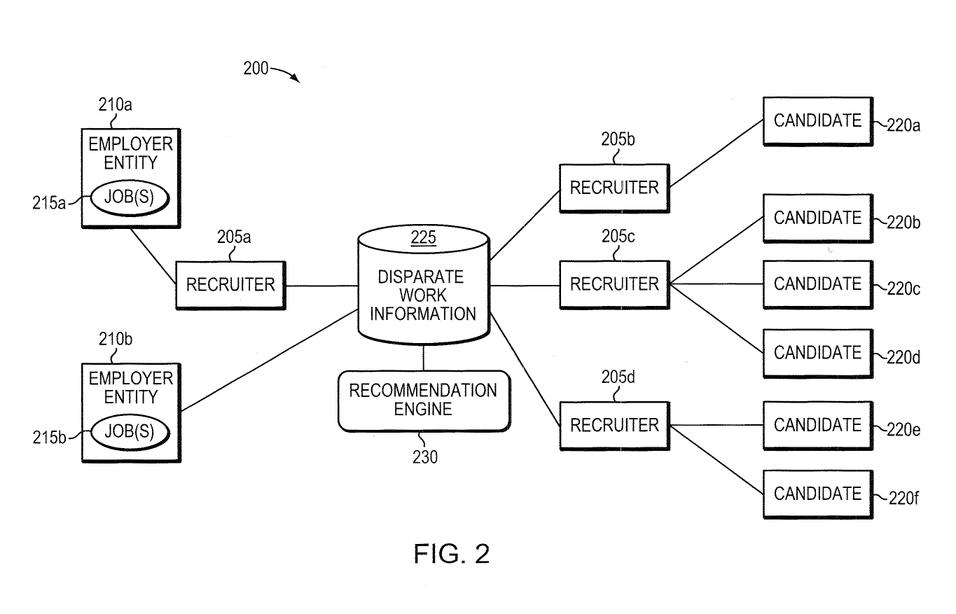

FIG. 2 is a block diagram illustrating a shared placement network 200 of the present invention capable of providing a recommendation of a shared placement collaboration. The network 200 includes recruiters 205a-d, and employer entities 210a, 210b having respective job openings 215a, 210b, and candidates 220a-f. The network 200 also includes a database, or similar structure, that includes the disparate work information 225 for the recruiters 205a-d and employer entities (e.g., company 210b) using the network service. The disparate work information 225 may include data (e.g., job information, candidate information, historical placement information) generated by the day-to-day operations of users (recruiters). The information is referred to as being “disparate” because it is made up of different and incongruous information. For example, the information includes the day-to-day, mission-critical business information of many different recruiters 205a-d, each of the recruiters being separate and accessing their own separate information. While each recruiter or employer entity has access to its own information and cannot see others' information, the invention system/service 200 has access to all of the information in the disparate work information 225.

Because the network service 200 may access all of the information, the service may access the disparate work information 225 to compare information regarding a current job opening 215a associated with one recruiter 205a to the information of other recruiters 205b-d, and create resulting comparison data representing correspondences between the current job opening 215a and the recruiters 205b-d. For example, recruiter 205c may have a track record of placing candidates in jobs that are very similar to job opening 215a. In this case, the service 200 may, using a recommendation engine 230 for example, identify recruiter 205c from the comparison data as likely to be representing a candidate that matches the job opening 215a, and may then generate a recommendation of a collaboration involving recruiter 205c. The service 200 may then present the recommendation to a user of the system, which may be the identified recruiter 205c or a recruiter 205a representing the current job opening 215a. In the case of a job opening 215b not represented by a recruiter, the recommendation may be presented to the employer entity 210b associated with the job opening 215b. Whether the information regarding a current job opening or candidate is compared to recruiters' historical placement information or other information, it is important that the service 200 searches the recruiters' information while maintaining its confidentiality.

In creating the comparison data, some embodiments may compare a title or description of the current job opening 215b to titles and descriptions used in historical placement information. The comparisons may be made using a set of keywords or skills generated from the source job description, which may be generated using open-source technology or commercial search products. The historical placement information may then be searched for placements with similar skills and keywords based on job title, job description, and candidates associated with the historical placements. Because the disparate work information 225 includes the day-to-day business transaction information of the recruiters 205a-d and employer entities 210a, 210b, the historical placement information may include copies of candidate resumes that are the subject of past placements made by the users of the network 200. In this case, some embodiments may create the comparison data by comparing information regarding the current job opening to the copies of the resumes in the historical placement information. In other embodiments, information regarding the current job opening may be compared to a recruiter's active candidate resumes, which may be included in the disparate work information 225, but not available for other recruiters to see.

To participate in the shared placement recommendation service the users may choose to opt-in to the service. Once participating in the service, users may explicitly designate certain jobs 215 or candidates 220 to share through the service, or may specify criteria used by the service to automatically identifying current job openings or candidates for which to include for consideration in the shared placement recommendation. Such criteria may include the length of time that a job 215 has been open or that a candidate 220 has been available, the location of the job or candidate, and the industry involved in the potential placement.

The recommendation made by the recommendation engine 230 may include an indication of the user 205 that has the greatest chance of completing a shared placement. Alternatively, or in addition to the indication, the recommendation may include a list of users as prospective trading partners, which may be filtered or sorted based on characteristics the user most prefers. Such characteristics may include the number of similar placements made by the other users, size of the other users' firm or organization, the users' ratings as provided by other trading partners, the total number of placements made with other trading partners, and users' locations. The characteristics may be set to default values that may be changed by the user.

An invoicing and billing system may be provided as part of the service for use by the trading partners, as well as a set of default trading partner terms, which may be later changed by the user to alleviate concerns of trading partners taking advantage of one another based on the default agreement. A rating system may also be incorporated into the service, which the users completing a shared placement arrangement through the system may use after their transactions are completed so that other users can see which users are highly rated. The users may also maintain an “inner circle” of other users that they regularly trade with and easily communicate and conduct transactions within that circle.

In one embodiment, the service 200 produces an ideal pairing (one job-representing recruiter 205 and one candidate-representing recruiter 205) and communicates to this pair. The communication keeps anonymous the particular candidate 220 or the particular job opening 215 that is the subject of the ideal pairing. For example, the communication may read “Mr. Job-Representing Recruiter, job order no. XXX may be a fit with Mr. Candidate-Representing Recruiter.” Alternatively, separate communications from the system 200 to each recruiter 205 may be made (e.g., “Dear Mr. Job-Representing Recruiter, we have found that Mr. Candidate-Representing Recruiter of NNN firm is a potential match for your job order no. XXX.”) A similar message may then be generated by the system to Mr. Candidate-Representing Recruiter in a web portal provided email or messaging system that various recruiters subscribe to. The web portal server may hold past recruiting records, copies of resumes, and other work items for recruiter members 205a-d of the portal, which may be stored in a secure manner in database 225 with access to a given piece of data only by the respective recruiter who created the data. Thus, the embodiments disclosed herein leverage the total pool of data that no individual user (e.g., recruiter) can see or access.

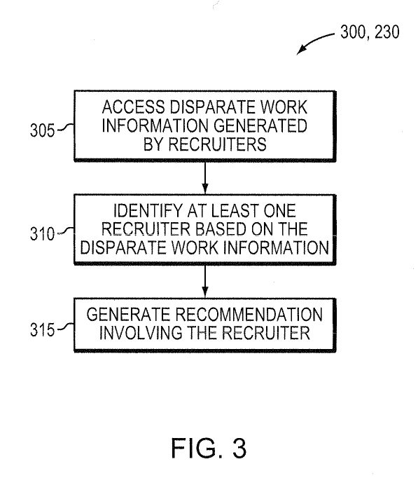

FIG. 3 is a flow diagram 300 of invention system 200 providing a recommendation of a shared placement collaboration. The recommendation process 300, a computer-implemented method, begins with step 305 accessing disparate work information 225 regarding a number of recruiters 205a-d, where the work information was originally generated by the recruiters 205a-d in the course of transacting their business. In some embodiments, the work information 225 may include historical placement information regarding placements made by the recruiters 205a-d. Step 310 uses the work information 225 to identify of at least one of the recruiters 205 as of interest for a potential shared placement collaboration. A recommendation for a collaboration with the identified recruiter 205 is then generated at step 315.

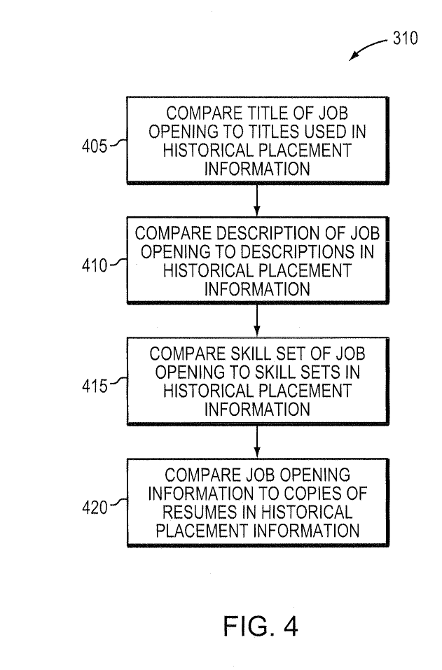

FIG. 4 is a flow diagram illustrating example ways that step 310 of FIG. 3 may identify recruiters based on disparate work information 225. In some embodiments, identifying the recruiter 205 may include comparing 405 information regarding a job opening 215 to historical placement information of the recruiter 205, which may involve comparing the title of the job opening 215 to titles used in past placements of the historical placement information. It may also include comparing 410 the description of the job opening 215 to descriptions used in the past placements of the historical placement information, or comparing 415 the skill set of the job opening 215 to skill sets used in the past placements of the historical placement information. If the historical placement information includes copies of the resumes of the candidates that were previously placed, step 420 compares the information regarding the job opening 215 to the contents of the resumes of those past-placed candidates. The system may use additional or different criteria for identify recruiters, and such criteria may be defined by the users of the system. Example other criteria may include the geography of the job opening or candidate, length of time the job opening or candidate has been available, or recruiter ratings.

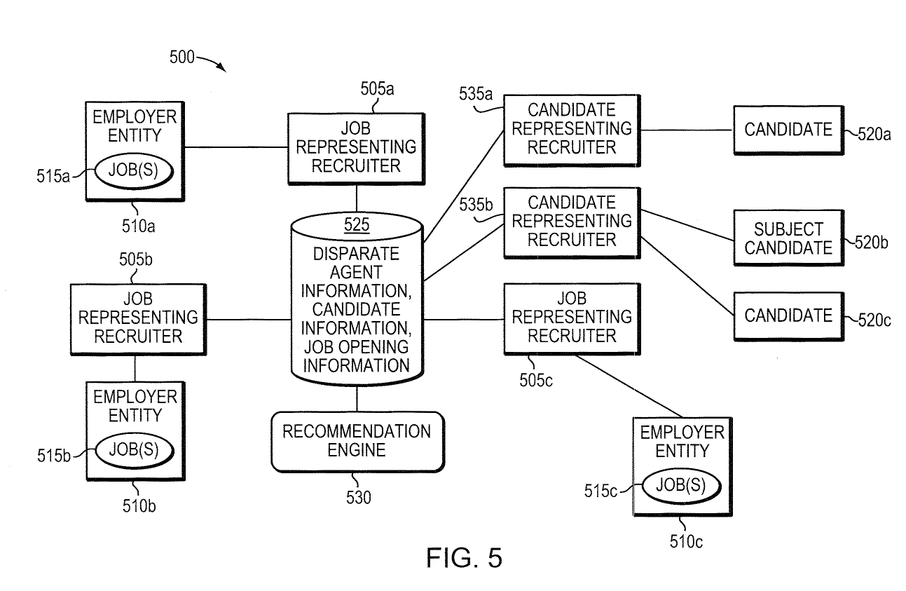

FIG. 5 is a block diagram illustrating another shared placement network 500 of the present invention capable of providing a recommendation for recruiter collaboration. The network 500 includes job-representing recruiters 505a-c, which are associated with employer entities 510a-c having respective job openings 515a-c, candidate-representing recruiters 535a, 535b, which are associated with candidates 520a-c looking to be placed in jobs, a database (or similar structure) that includes disparate work information 525, and a recommendation engine 530. In the course of the recruiters' workflow, the database stores disparate information 525 generated by the recruiters of the network 500 (e.g., candidate-representing recruiters 535a, 535b and job-representing recruiters 505a-c). Information regarding the candidates 520a-c and job openings 515a-c is also stored at 525 during the day-to-day workflow of the recruiters 505a-c, 535a, 535b. For a subject candidate 520b, recommendation engine 530 (or network system 500 as otherwise configured) compares information regarding the subject candidate 520b to the stored disparate job opening information and respective job-representing recruiter information 525. This comparison results in comparison data representing correspondences between the subject candidate 520b and the job openings 515a-c and job-representing recruiters 505a-c. From the comparison data, recommendation engine 530/system 500 identifies at least one job-representing recruiter 505 and generates a recommendation of a collaboration with the identified job-representing recruiter 505. Network system 500 then presents the recommendation to the candidate-representing recruiter 535b that is associated with the subject candidate 520b.

As in the embodiments presented above, storing the disparate work information 525 may include storing historical job opening information regarding job openings handled by the job-representing recruiters 505a-c. In this case, the comparison data may be created by comparing the information regarding the subject candidate 520b to the historical job opening information stored at 525, as described above for the historical placement information. Alternatively, or in addition to historical job opening comparisons, the comparison data may be created by comparing the information regarding the subject candidate 520b to currently open jobs stored at 525. Using this comparison data, job-representing recruiters 505a-c most likely to be representing a job opening 515 for which the subject candidate 520b is suited are identified.

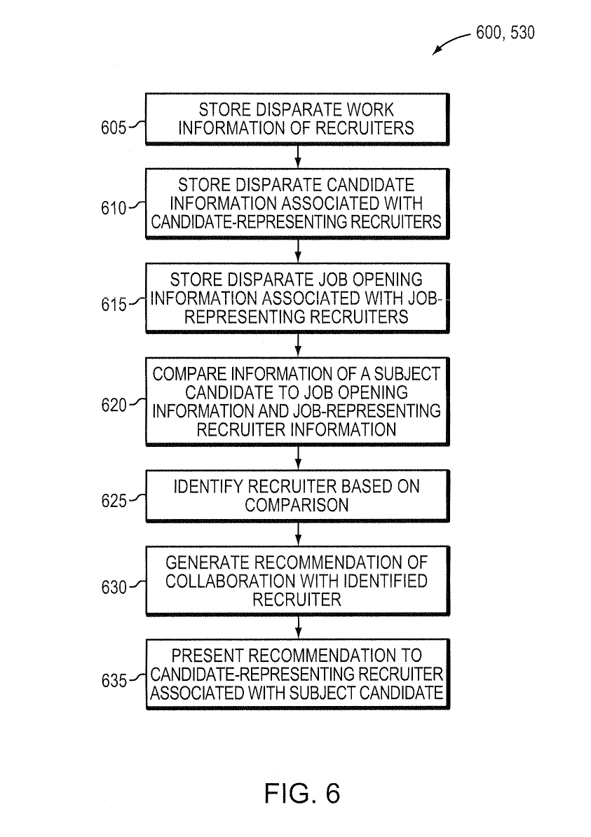

FIG. 6 is a flow diagram 600 of recommendation engine 530 providing a recommendation for recruiter collaboration. The recommendation may be provided by a computer-implemented method that stores at 525 disparate information generated by a number of candidate-representing recruiters 535 and job-representing recruiters 505, candidates 520, and job openings 515 during the course of recruiter workflow (605, 610, 615). Next, step 620 compares information regarding a subject candidate 520b to the stored disparate job opening information and job-representing recruiter information, and creates resulting comparison data that represents correspondences between the subject candidate 520b and the job openings 515 and job-representing recruiters 505. From the comparison data, step 625 identifies at least one job-representing recruiter 505, and the recommendation engine 530, at step 635, generates a recommendation of a collaboration with the identified recruiter 505. The recommendation engine 530 then presents the recommendation to the candidate-representing recruiter 535b that is associated with the subject candidate 520b.

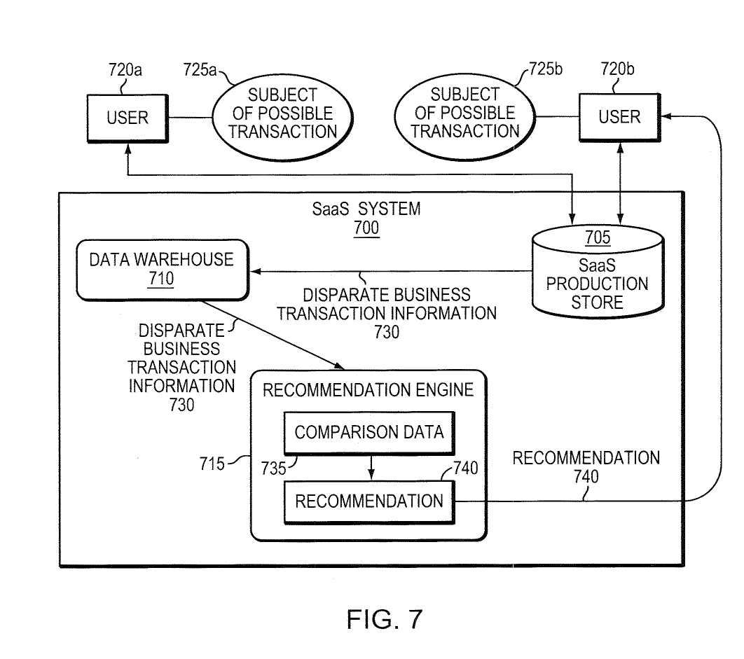

FIG. 7 is a block diagram illustrating a system 700 of the present invention for connecting two users of a software-as-a-service (SaaS) system. The system 700 includes at least one SaaS production datastore 705 containing disparate information generated and used by the system's users 720a, 720b during their normal day-to-day business transactions. This information may include any data stored or created by the users 720a, 720b, which may include historical transaction information regarding business transactions completed by the users (e.g., past shared placements in an employment recruiting system). The information may also include information regarding the users' possible transactions 725a, 725b that may be the subject of a future transaction.

The system 700 further includes a data warehouse 710 used to extract from the SaaS production datastore 705 disparate business transaction information 730 regarding the users 720a, 720b of the SaaS system 700, and includes a recommendation engine 715 coupled to access the information 730 from the data warehouse 710. Using the disparate information 730, the recommendation engine 715 creates comparison data 735 by comparing information regarding at least one of the users' possible transactions 725a, 725b to the historical transaction information in the disparate information 730. The comparison data 735 represents correspondences between a possible transaction 725a, 725b and the users 720a, 720b. From the comparison data 735, the recommendation engine 715 generates a recommendation 740 for a collaboration between two users of the system 700, one user being the user with the subject of a possible transaction and the other user being a user with a sought-after object that would likely be involved in the transaction. For example, user 720a may be the user that is the most likely to be involved with possible transaction 725b of user 720b. In this case, the recommendation 740 is presented to user 720b because user 720b is the user corresponding to the possible transaction 725b. As would be appreciated by one skilled in the art, the SaaS system 700 may be an applicant tracking system and the users may include recruiters using the applicant tracking system.

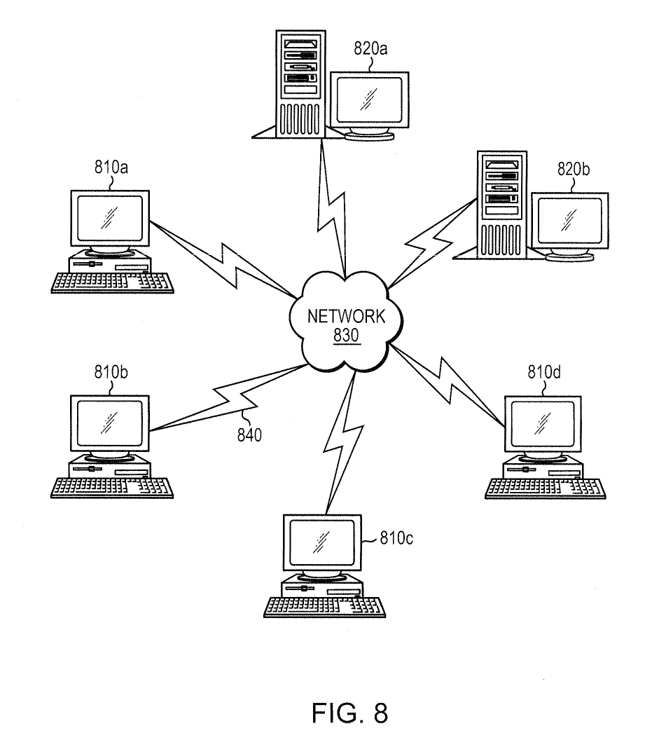

FIG. 8 is a schematic view of a computer network in which embodiments of the present invention may operate. Client devices 810 and server devices 820 provide processing, storage, and input/output devices executing application programs and the like. Client devices 810 can also be linked through a communications network 830 to other computing devices, including other client devices 810 and server devices 820. The communications network 830 may be part of a remote access network, a global network (e.g., the Internet), a worldwide collection of computing devices, local area or wide area networks, and gateways that currently use respective protocols (TCP/IP, Bluetooth, etc.) to communicate with one another. Other electronic device/computer network architectures are also suitable.

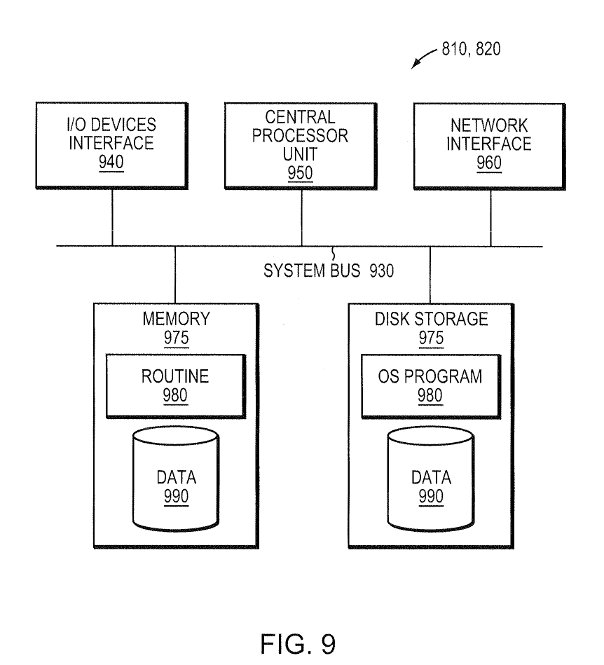

FIG. 9 is a block diagram of a computer node/device 810, 820 in the network of FIG. 8. Each device 810, 820 contains a system bus 930, where a bus is a set of hardware lines used for data transfer among the components of a device or processing system. The bus 930 is essentially a shared conduit that connects different elements of a device (e.g., processor, disk storage, memory, input/output ports, network ports, etc.) that enables the transfer of information between the elements. Attached to the system bus 930 is an I/O device interface 940 for connecting various input and output devices (e.g., keyboard, mouse, displays, printers, speakers, etc.) to the device 810, 820. A network interface 960 allows the device to connect to various other devices attached to a network (e.g., network 830 of FIG. 8). Memory 970 provides volatile storage for computer software instructions 980 and data 990 used to implement an embodiment of the present invention (e.g., the database 225, 525, 705, 710, recommendation engine 230, 530, 715, user interfaces, and supporting code detailed above in FIGS. 1-7). Disk storage 975 provides non-volatile storage for computer software instructions 980 and data 990 used to implement an embodiment of the present invention. Central processor unit 950 is also attached to the system bus 930 and provides for the execution of computer instructions.

In one embodiment, the processor routines 980 and data 990 are a computer program product (generally referenced 980), including a computer readable medium (e.g., a removable storage medium such as one or more DVD-ROM's, CD-ROM's, diskettes, tapes, or a portal server medium, etc.) that provides at least a portion of the software instructions for the invention system. Computer program product 980 can be installed by any suitable software installation procedure, as is well known in the art. In another embodiment, at least a portion of the software instructions may also be downloaded over a cable, communication and/or wireless connection.

While this invention has been particularly shown and described with references to example embodiments thereof, it will be understood by those skilled in the art that various changes in form and details may be made therein without departing from the scope of the invention encompassed by the appended claims. For example, the disclosed embodiments have been described in the context of a recruiting environment, but may be similarly applied to other environments. Generally, work information generated by a number of different entities during the course of the entities transacting business may be accessed and compared to information regarding a possible transaction, resulting in comparison data representing correspondences between the possible transaction and the entities. From the comparison data, at least one of the entities may be identified and a recommendation of a collaboration with the identified entity may be generated.

What is claimed is:

1. A computer-implemented method of providing a recommendation for recruiter collaboration, the method comprising:
accessing disparate work information regarding a plurality of recruiters, the work information being as originally generated by the recruiters in the course of transacting business;
identifying at least one recruiter from the plurality of recruiters based on the disparate work information; and
generating a recommendation for collaboration with the identified recruiter.

2. A method as in claim 1 wherein (i) the work information includes historical placement information regarding placements made by the recruiters and (ii) identifying at least one recruiter includes identifying at least one recruiter from the plurality of recruiters based on the historical placement information.

3. A method as in claim 2 wherein identifying the at least one recruiter includes comparing information regarding a current job opening to the historical placement information.

4. A method as in claim 3 wherein identifying the at least one recruiter includes identifying recruiters likely to be representing a candidate that matches the current job opening.

5. A method as in claim 3 further including presenting the recommendation to a user.

6. A method as in claim 5 wherein the user is one of (i) the identified recruiter and (ii) a recruiter representing the current job opening.

7. A method as in claim 5 wherein the user is an employer entity associated with the current job opening.

8. A method as in claim 3 wherein comparing information regarding the current job opening to the historical placement information includes any combination of (i) comparing a title of the current job opening to titles used in the historical placement information, (ii) comparing a description of the current job opening to descriptions in the historical placement information, and (iii) comparing a skill set of the current job opening to skill sets in the historical placement information.

9. A method as in claim 3 wherein (i) the historical placement information includes copies of candidate resumes and (ii) comparing information regarding the current job opening to the historical placement information includes comparing the information regarding the current job opening to the copies of resumes in the historical placement information.

10. A method as in claim 1 further comprising automatically identifying current job openings or available candidates for which to perform the identifying and generating steps.

11. A method as in claim 1 wherein (i) the plurality of recruiters includes recruiters representing job openings and (ii) the disparate work information includes information regarding the job openings and respective recruiters; and
further comprising comparing information regarding a current candidate to any combination of (i) the information regarding the job openings and (ii) respective recruiter historical job opening data.

12. A computer-implemented method of providing a recommendation of a collaboration, the method comprising:
accessing work information generated by respective entities during the course of the entities transacting business, the work information including historical transaction information regarding transactions completed by the entities;
comparing information regarding a possible transaction to the historical transaction information, resulting in comparison data representing correspondences between the possible transaction and the entities; and
identifying from the comparison data at least one entity; and
generating a recommendation of a collaboration with the identified entity.

13. A method as in claim 12 further including presenting the recommendation to a potential transaction participant.

14. A method as in claim 12 wherein (i) the entities include recruiters in a job placement universe, (ii) the historical transaction information includes historical placement information regarding placements made by the recruiters, and (iii) the possible transaction includes a job opening or candidate for employment.

15. A method as in claim 14 wherein identifying at least one entity includes identifying entities likely to be (i) representing a candidate that matches a subject job opening or (ii) representing a job opening for which a subject candidate is a match.

16. A method as in claim 14 further including presenting the recommendation to at least one of (i) the identified entity, (ii) a candidate for employment, and (iii) an employer entity associated with a current job opening.

17. A computer-implemented method of providing a recommendation for recruiter collaboration, the method comprising:
during respective recruiter workflow, storing (i) disparate work information generated by a plurality of candidate-representing recruiters and job-representing recruiters, (ii) disparate candidate information regarding a plurality of candidates, each candidate being associated with at least one of the candidate-representing recruiters, and (iii) disparate job opening information regarding a plurality of job openings, each job opening being associated with at least one of the job-representing recruiters;
comparing candidate information of a subject candidate to the stored disparate job opening information and respective job-representing recruiter information, resulting in comparison data representing correspondences between the subject candidate and the plurality of job openings and job-representing recruiters;
identifying from the comparison data at least one respective job-representing recruiter;
generating a recommendation of a collaboration with the identified job-representing recruiter; and
presenting the recommendation to a candidate-representing recruiter associated with the subject candidate.

18. A method as in claim 17 wherein (i) storing the disparate work information includes storing historical job opening information regarding job openings handled by the job-representing recruiters and (ii) comparing the candidate information includes comparing the candidate information to the historical job opening information.

19. A method as in claim 17 wherein identifying at least one respective job-representing recruiter includes identifying job-representing recruiters likely to be representing a job opening for which the subject candidate is a match.

20. A system for connecting two users of a software-as-a-service (SaaS) system, comprising:
a data warehouse extracting from SaaS production datastores disparate business transaction information regarding a plurality of users of the SaaS system, the users being associated with different organizations, and the information being generated by the users in the course of transacting business and including historical transaction information regarding transactions completed by the users; and
a recommendation engine coupled to access information from the data warehouse and configured to (i) compare information regarding a possible transaction to the historical transaction information, resulting in comparison data representing correspondences between the possible transaction and the plurality of users, (ii) generate from the comparison data a recommendation for a collaboration between a SaaS user associated with the possible transaction and another SaaS user, the users being associated with different organizations, and (iii) present the recommendation to the SaaS user associated with the possible transaction.

21. A system as in claim 20 wherein (i) the SaaS system is an applicant tracking system and (ii) the plurality of users includes recruiters using the applicant tracking system.

22. A system as in claim 21 wherein (i) the historical transaction information includes historical placement information regarding placements made by the recruiters and (ii) the possible transaction includes a current job opening or candidate for employment.

23. A system as in claim 22 wherein the possible transaction is a current job opening, and the recommendation engine creates the comparison data by any combination of (i) comparing a title of the current job opening to titles used in the historical placement information, (ii) comparing a description of the current job opening to descriptions in the historical placement information, and (iii) comparing information regarding the current job opening to copies of resumes in the historical placement information.

24. A system as in claim 22 wherein the recommendation includes an identification of at least one recruiter likely to be representing a candidate that matches the current job opening.
